(19) United States
(12) Patent Application Publication
(10) Pub. No.: US 2013/0206786 A1
(43) Pub. Date: Aug. 15, 2013

(54) Confectioneries Dispenser

(71) Applicants: Sidney Diamond, Barrington Hills, IL (US); Dennis Kupperman, Glenview, IL (US)

(72) Inventors: Sidney Diamond, Barrington Hills, IL (US); Dennis Kupperman, Glenview, IL (US)

(21) Appl. No.: 13/370,615

(22) Filed: Feb. 10, 2012

(51) Int. Cl. B65D 83/04; B65G 59/02

(52) U.S. Cl. 221/24; 221/248; 221/198; 221/282

(57) ABSTRACT

A confectioneries dispenser including a magazine for carrying a number of the confectioneries for dispensing and a head mounted for movement from a closed position to a dispensing position dispensing the outermost of the confectioneries from the magazine. For returning the head from the dispensing position to the closed position a spring is integrally formed as part of the magazine. To carry spherical confectioneries the magazine is integrally molded with a partially cylindrical enclosure of greater than one hundred and eighty degrees having a semi-cylindrical portion with a pair of straight tangential edge extensions, and a wedge shaped track inside of each extension. An outer case which receives a lower portion of the magazine has an upper projection corresponding and cooperating with a projection on a lower part of the head to simulate the lower and upper parts of a character's mouth.

### BACKGROUND OF THE INVENTION

1. Field of the Invention

This invention relates generally to confectionery dispensing devices and more particularly to portable dispensers for generally spherical confectioneries such as gumballs and jawbreaker candies.

2. Background Art

Confectioneries, particularly candy and gum, have long been popular with children and adults alike. Dispensers of individual pieces or small quantities of confectioneries are particularly popular with children. Many devices for dispensing confectioneries, while portable in the sense that they may be moved from one location to another, are not readably carried upon the person of the user. There have, however, been numerous portable, handheld devices for the dispensing of individual flat, generally rectangular or cylindrical solid, pieces of candy. Examples of such candy dispensers in which the upper portion of a handheld dispenser is manipulated to eject a piece of candy from adjacent the top of a magazine containing a number of upwardly spring biased pieces, and components of them, are shown in Haas U.S. Pat. No. 4,966,305 issued Oct. 30, 1990; Hinterreiter U.S. Pat. No. 5,660,516 issued Oct. 1, 1996; Chan U.S. Pat. No. 5,785,206 issued Jul. 28, 1998; Konig et al. U.S. Pat. No. 5,984,285 issued Nov. 16, 1999; and Konig U.S. Pat. No. 7,523,841 issued Apr. 28, 2009. Such devices require manipulation of the top of the dispenser by the user's hand holding the dispenser or a finger or the thumb of the other hand.

Portable dispensers for spherical confections are disclosed in Diamond et al. U.S. Pat. No. 5,385,267 issued Jan. 31, 1995 and Diamond U.S. Pat. No. 5,779,095 issued Jul. 14, 1998 in which a tubular reservoir for spherical confectioneries is movable with respect to a substantially hollow base for dispensing a single spherical confectionery. Nevertheless, there remains a need for a portable, handheld dispenser of generally spherical confectioneries such as gumballs and jawbreaker candies which may be readily carried upon the person of the user and readily actuated in any number of ways to dispense a single piece of a generally spherical confectionery, preferably with only one hand, without requiring any particular proficient digital dexterity.

### SUMMARY OF THE INVENTION

The present invention is concerned with providing a confectioneries dispenser having a magazine carrying a number of the confectioneries, a spring inside the magazine urging the confectioneries out of the magazine, a head mounted for movement from a closed position to a dispensing position dispensing the outermost of the confectioneries from the magazine, and a spring integrally formed as part of the magazine for returning the head from the dispensing position to the closed position. The head may be mounted on the magazine for pivotal movement.

The integrally formed spring may include a first portion of the magazine extending beyond the outermost of the confectioneries and having an inner end and an outer end, a second portion extending from the outer end of the first portion generally transverse to the first portion to an outer end of the second portion, and a third portion transverse to the first portion and extending adjacent the inner end of the first portion in a direction transverse to the direction the second portion extends. The magazine may have a pair of spaced apart walls extending beyond the outermost of the confectioneries. The third portion may extend between and be connected to the sidewalls. An integral section may extend between the spaced apart wall and the first portion may be formed from the section by a pair of spaced apart slits in the section.

The head may include an elongated ejector that, when the head is moved to the dispensing position, pushes out only the outermost of confectioneries from the magazine and blocks the remaining confectioneries from being urged out by the bias of the spring inside the magazine urging the confectioneries out of the magazine. The confectioneries dispenser may include an outer case having an open end with the magazine carrying the confectioneries being at least partially inside the outer case, and a portion of the magazine adjacent the open end causing an interference fit with the outer case.

The present invention is also concerned with providing a spherical confectioneries dispenser having a magazine carrying a number of the spherical confectioneries, and the magazine having a partially cylindrical enclosure of greater than one hundred and eighty degrees for retaining the spherical confectioneries. The partially cylindrical enclosure of greater than one hundred and eighty degrees may include a semi-cylindrical portion, a pair of tangential edge extensions, and a wedge shaped track inside of each extension to increase the cylindrical enclosure of the semi-cylindrical portion. The semi-cylindrical portion, the tangential edge extensions, and the wedge shaped tracks may all integrally molded as part of the magazine.

The present invention is further concerned with providing a confectioneries dispenser having an outer case, a magazine at least partially inside the outer case carrying a number of the confectioneries, a head mounted above the outer case for movement from a closed position to a dispensing position dispensing the outermost of the confectioneries from the magazine, the head having a lower front projection adjacent the outer case in the closed position of the head, and the outer case having an upper front projection corresponding to the lower front projection of the head. The lower front projection of the head and the upper front projection of the outer case may simulate the upper and lower jaws or lips of a character's mouth. The lower front projection of the head may be integrally formed as part of the head and the upper front projection of the outer case may be a separate piece secured to tabs integrally formed as part of the outer case.

### BRIEF DESCRIPTION OF THE DRAWINGS

For a better understanding of the present invention, reference may be had to the accompanying drawings in which:

FIG. 1 is a front perspective view of an embodiment of the present invention in the process of dispensing a gumball;

FIG. 2 is a front perspective view of the embodiment of the present invention shown in FIG. 1 in the process of dispensing a gumball;

FIG. 3 is a rear elevation of the embodiment shown in FIG. 1;

FIG. 4 is an exploded perspective view of showing components of the embodiment shown in FIG. 1;

FIG. 5 is an enlarged scale bottom plan view of the embodiment shown in FIG. 1;

FIG. 6 is a top plan view of the case of the embodiment shown in FIG. 1;

FIG. 7 is an enlarged scale generally central vertical sectional view of the outer case of the embodiment shown in FIG. 1;

FIG. 8 is an elevation of the magazine of the embodiment shown in FIG. 1;

FIG. 9 is a rear view of the magazine of the embodiment shown in FIG. 1;

FIG. 10 is an enlarged scale sectional view taken generally along line 10-10 of FIG. 9 with a gumball;

FIG. 11 is a an enlarged scale fragmentary front view of the lower portion of the magazine with gumballs;

FIG. 12 is an enlarged scale fragmentary sectional view of the head return spring of the embodiment shown in FIG. 1;

FIG. 13 is an enlarged scale fragmentary sectional view of the head return spring of the embodiment shown in FIG. 1 in a flexed condition in dashed line;

FIG. 14 is an enlarged scale top plan view of the cap of the embodiment shown in FIG. 1;

FIG. 15 is an enlarged scale side elevation of the cap of the embodiment shown in FIG. 1;

FIG. 16 is an enlarged scale back view of the cap of the embodiment shown in FIG. 1;

FIG. 17 is a bottom plan of the head of the embodiment shown in FIG. 1;

FIG. 18 is an enlarged scale generally central vertical sectional view of the head of the embodiment shown in FIG. 1 taken generally along line 18-18 of FIG. 17;

FIG. 19 is a sectional view of the head of the embodiment shown in FIG. 1 taken generally along line 19-19 of FIG. 17;

FIG. 20 is a side elevation of another embodiment of the present invention;

FIG. 21 is a rear view of the embodiment shown in FIG. 20; and

FIG. 22 is a perspective view of the embodiment shown in FIGS. 20 and 21 in the process of dispensing a confectionery.

### DETAILED DESCRIPTION

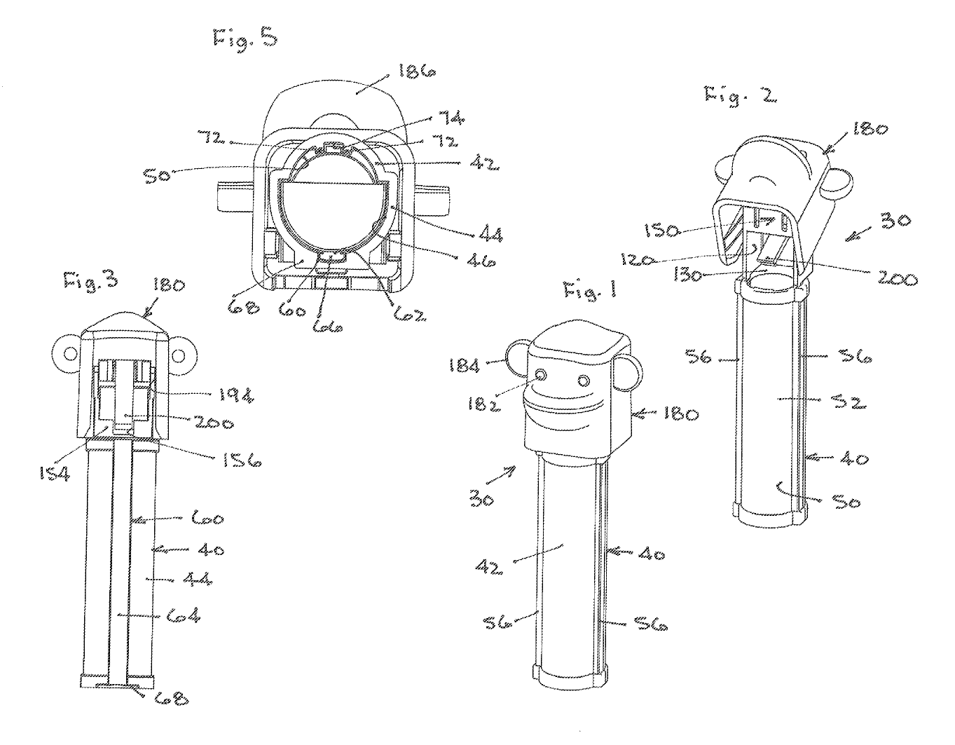

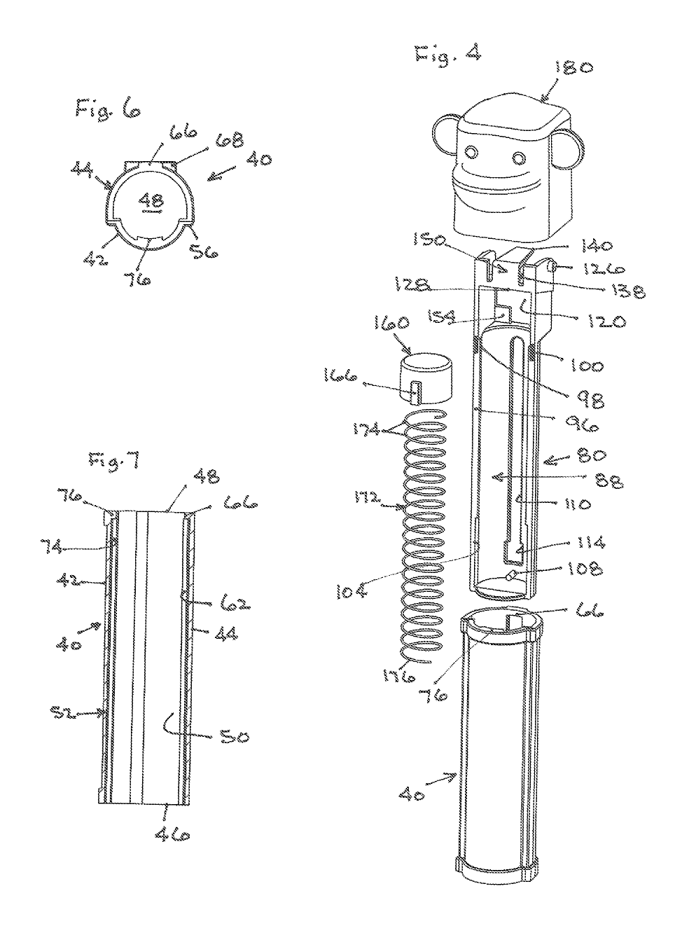

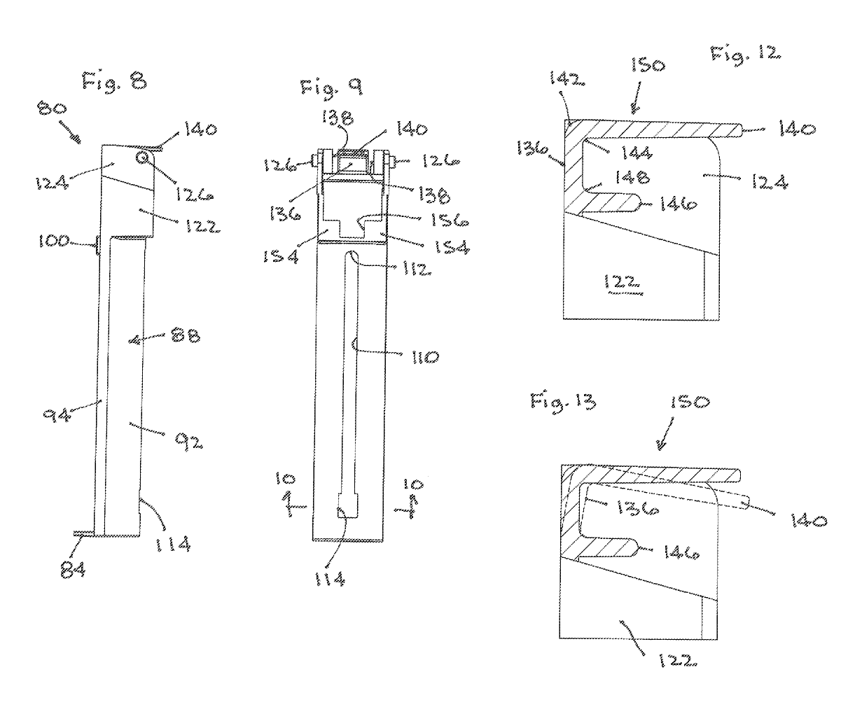

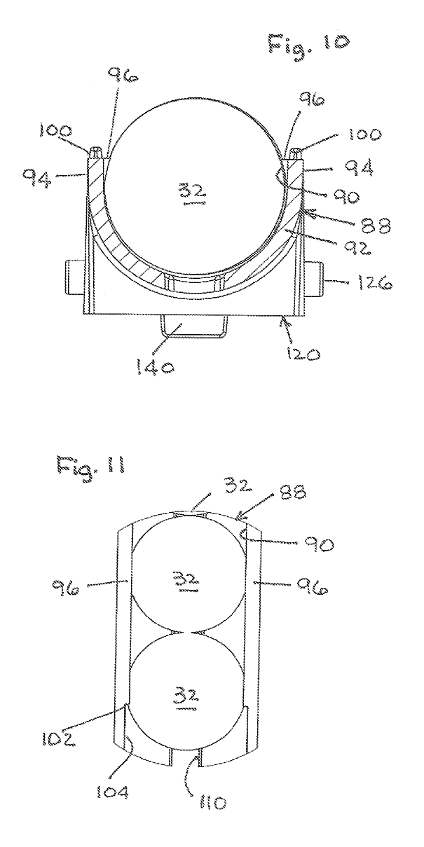

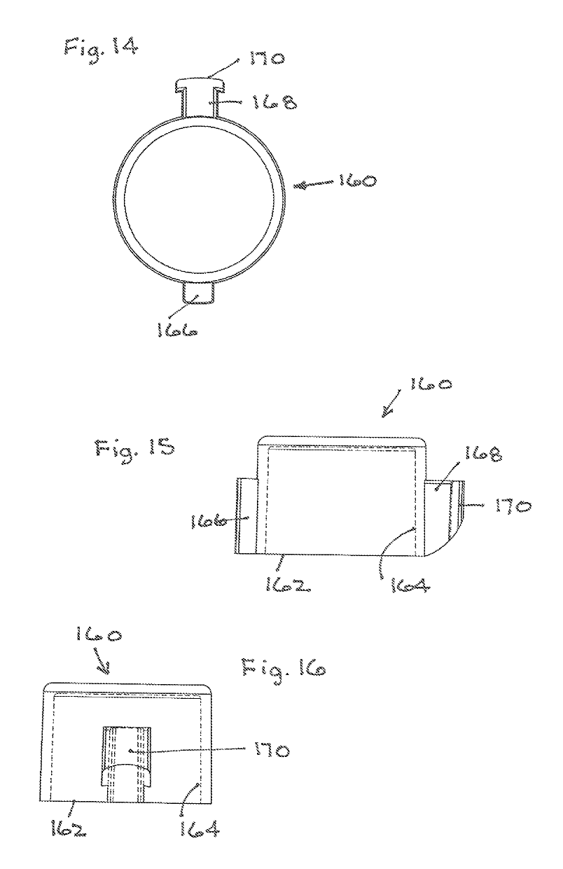

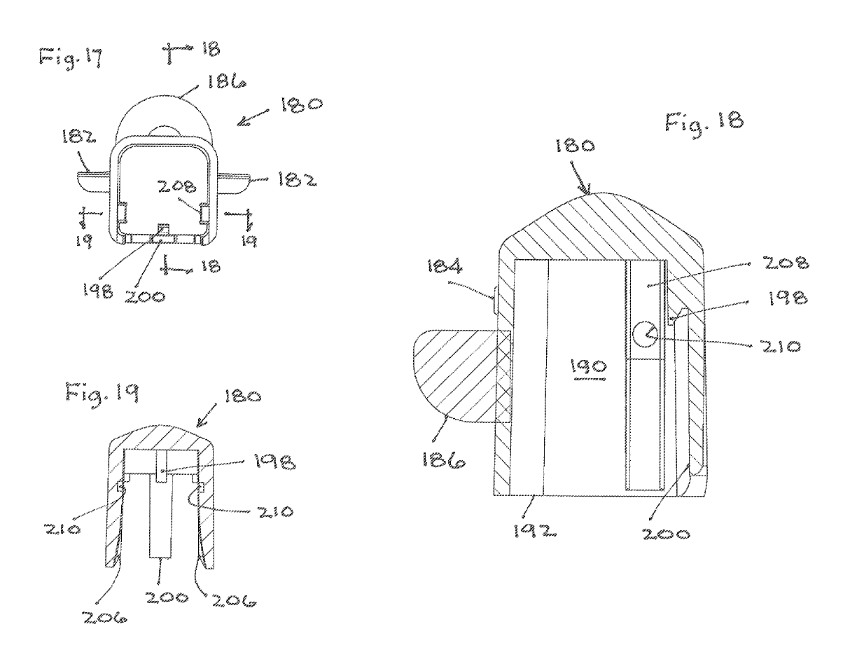

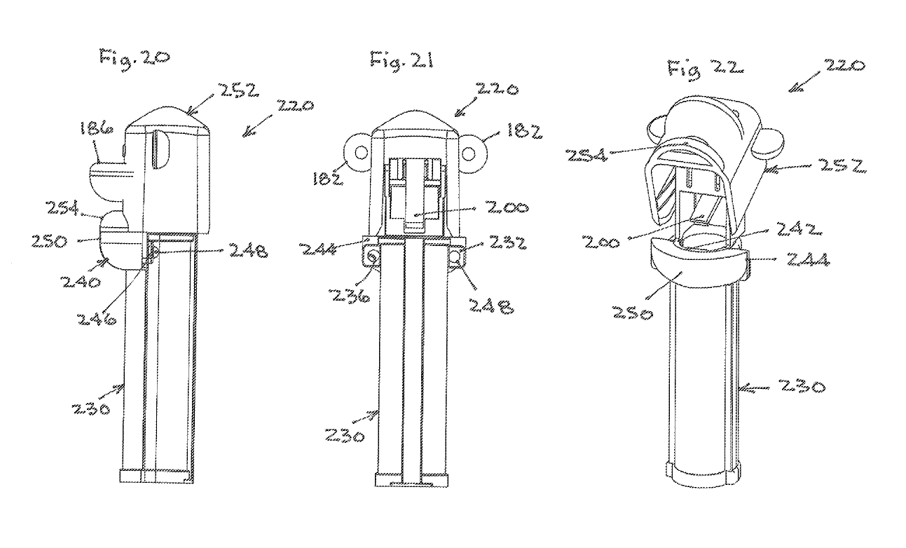

Referring now to the drawings, in which like elements are identified by like reference numerals, there is shown in FIGS. 1-19 a dispenser 30 for spherical confectionaries such as gumballs 32 or jawbreaker type candies (not shown). Dispenser 30 includes a outer case 40 which has a front semi-cylindrical portion 42 and a back semi-cylindrical portion 44. Outer case 40 as formed by front portion 42 and back portion 44 has an open bottom 46 and an open top 48. As is perhaps best illustrated in FIG. 5, front portion 42 has a smaller diameter than rear portion 44. Accordingly, neither interior 50 nor exterior 52 of outer case 40 is actually cylindrical. The resulting appearance when viewed from the front as in FIGS. 1 and 2, is that the front of outer case 40 has an apparent vertical post 56 on each side.

Back portion 44 has a generally centrally vertically disposed protrusion 60 which results in a narrow slot 62 in interior 50 and a narrow flat panel 64 on exterior 52. Slot 62 has a closed top 66 as is shown in FIGS. 4 and 5. Panel 64 may conveniently be used for the display of information such the name of the manufacturer, the country of manufacture or patent information. At the bottom of panel 64 is a rearward protruding foot 68 which is substantially wider than panel 64 and helps stabilize dispenser 30 in an upright position on a substantially flat surface. Front portion 42 has a pair of generally centrally vertically disposed inward projecting spaced apart ribs 72 defining a slot 74 with a closed top 76. Slot 74 is substantially diametrically opposed to slot 62.

A magazine 80 made of high impact polystyrene (HIPS) or some other plastic having sufficient resiliency is received in interior 50 of outer case 40 through open top 48. Most of magazine 80 is generally tubular and carries a number of gumballs 32 having an appropriate size (diameter) to fit the dispenser. As an example the magazine may be conveniently sized to carry five gumballs each having diameter of about 0.575 inches. Magazine 80 has a generally circular bottom wall 84. Extending upwardly from bottom wall 84 is a partially cylindrical wall 88 encompassing approximately 200 degrees with an arcuate front opening 90 of approximately the remaining 160 degrees. More particularly, wall 88, as is best illustrated in FIG. 10, has a semi-cylindrical portion 92 and a pair of tangential edge extensions 94. Inside of each extension 94 is a wedge shaped track 96 which extends from top 98 of extension 94 to a point 102 spaced from bottom wall 84. Wedge shaped tracks 90 extend the cylindrical enclosure of wall 88 to retain gumballs 32 inside the magazine, particularly when the user is refilling the magazine. Adjacent top 98, a locking rib 100 extends a little above each wedge 96.

Between points 102 and bottom wall 84 there is a larger, one-hundred and eighty degrees, opening 104. Projecting inwardly from generally the center of wall 88 spaced above a bottom wall 84 of the magazine is a pin 108. Wall 88 has a narrow vertical slot 110 extending upwardly and generally aligned with pin 108. Slot 110 has an arcuate top 112 and an enlarged generally rectangular opening 114 at the bottom of the slot, spaced above pin 108.

Atop partially cylindrical wall 88 is an integrally molded dispensing chamber 120, which as illustrated in FIGS. 2 and 4, is positioned above outer case 40 when magazine 80 is seated in the outer case. The lower outer surfaces of each of a pair of spaced apart side walls 122 are co-planar with the outer surfaces of extensions 94. An upper shoulder 124 on each of side walls 122 extends further out than the lower surfaces and opposed pins 126 extend even further out laterally from adjacent the upper rear corners of each of the upper shoulders. Spanning across the front of the upper shoulders is a bridge 128. Side walls 122, which extend above the top or outermost of gumballs 32, and the lower edge of bridge 128 define a front dispensing opening 130 from dispensing chamber 120 adjacent the top of arcuate opening 90.

Bridge 128 has a generally central vertical upward portion 136 formed by a pair of slits 138 extending down from the top of the bridge. Slits 138 are each spaced from their respective side shoulder 124, as well as being spaced from each other by portion 136. An integral generally horizontal leaf 140 extends rearward from the top of portion 136. There is a radius 142 transitioning from the outer top of vertical portion 136 to the upper surface of leaf 140 which is larger than radius 144 between the inside of vertical portion 136 and the lower surface of leaf 140. As shown in FIG. 4, leaf 140 is trapezoidal when viewed from the top and extends beyond the back of chamber 120 and wall 88 as best shown in FIGS. 8 and 10.

Adjacent the bottom of vertical portion 136 a generally horizontal ledge 146 which also extends rearward and spans between shoulders 124. There is a large radius 148, similar to radius 142, between the inside of vertical portion 136 and the upper surface of ledge 146. Leaf 140, vertical portion 136 and ledge 146 form a spring 150 of which leaf 140 and vertical portion 136 flex as illustrated in FIG. 13 when a downward force is exerted on the top of the leaf 140 adjacent it's back end. At the back of dispensing chamber 120 are a pair of lower corner walls 154, each extending inward from a respective one of spaced apart side walls 122. Between corner walls 154 is a passage 156.

Mounted for reciprocating vertical movement in magazine 80 is a cap 160 having an open bottom 162 and a hollow interior 164. Extending laterally from adjacent the bottom of cap is a front tab 166. Substantially diametrically opposed from front tab 166 is a back laterally extending tab 168 with a flanged free end 170. Insertion of cap 160 into magazine 80 is facilitated by a larger, one-hundred and eighty degree, opening 104 between points 102 and bottom wall. Flanged free end 170 of back tab 168 fits through enlarged generally rectangular opening 114 securing tab 168 for vertical movement in slot 110. A coil spring 172 fits in magazine 80 between bottom wall 90 and cap 160. More particularly upper coils 174 of the spring fit into hollow interior of cap 160 and a single lower coil 176 fits in the space between bottom wall 90 and pin 88 that is less than twice the diameter of the coiled wire.

Front tab 166 is received for vertical sliding movement in slot 74 between ribs 72 of outer casing 40 and back tab 168, more particularly free end 170, is received in slot 62 when magazine 80 is inserted in outer case 40. Cap 160 needs to be angled downward during assembly of magazine 80 into outer case 40 so front tab 166 passes the designed obstruction of closed top 76 of slot 74 allows the unit to snap and lock together keeping cap 160 inside outer case 40. A portion magazine 80 which is adjacent open top end 48 of case 40 includes locking ribs 100, designed to cause an interference fit between the front of magazine 80 partially inside outer case 40 and open top end 48 of outer case 40. Magazine 80 may be partially upwardly extracted from outer case 40 to reload the magazine with additional gumballs 32 by the user overcoming the interference fit between ribs 100 and case 40. Cap 160 is retained in magazine 80 and outer case 40 during such refilling by front tab 166 being kept in slot 74 and back tab 168 being kept in slot 62.

Mounted for pivotal movement on dispensing chamber 120 is a head 180. On the outside of head 180, ears 182, eyes 184 and a nose or mouth 186 may be integrally provided. Although illustrated in the drawing as a rough generic caricature, the outer appearance of head 180 may be designed as a licensed character or. person. Head 180 has a hollow interior 190, an open bottom 192, and a mostly open back 194. Within interior 190, more particularly generally centrally disposed from side to side and inboard of the back of the head is an integral depending projection 198. Spaced rearward or outboard from projection 198 is an also generally centrally disposed integral depending elongated ejector 200 which extends down almost to the bottom of head 180.

The lower inside lateral edges of head 180 have chamfers 206. Extending upwardly from the bottom interior of head 180 is a pair of substantially diametrically opposed channels 208. Adjacent the upper end of each of channels 208 is a socket 210 for receiving one of pins 126.

Head 180 is molded of acrylonitrile butadiene styrene (ABS), high impact polystyrene (HIPS), or some other plastic having sufficient resiliency that the sides of the head may be spread apart enough to push the laterally opposed pins 126 of dispensing chamber 120 up channels 208 and into sockets 210. Once each of pins 126 is seated in a respective socket 210, the resiliency of head 180 will retain head 180 mounted on magazine 80 for pivotal movement about the axis of pins 126.

With head 180 mounted on magazine 80 and with magazine 80 in outer case 40 and loaded with gumballs 32, a gumball 32 may be dispensed by a user pivoting the top of the head downward and rearward with a singlehanded thumb action. Such pivotal movement of head 180 will pivot elongated ejector 200 forward and upward through passage 156 to both push only the topmost gumball in magazine 80 out through opening 130 of dispensing chamber 120 while at the same time blocking the gumballs remaining in magazine 80 from being pushed out by the bias of spring 172. Upon release of head 180 by the user, the head will be returned to its forward upright position by the bias of spring 150. Cap 160 urged upward by coil spring 172 will then push the next gumball up to be dispensed by another single handed thumb action to pivot head 180 downward and rearward against the bias of spring 150.

In an alternative embodiment of a dispenser 220 illustrated in FIGS. 17-19, a modified outer case 230, which is otherwise the same as outer case 40, has integrally molded out lateral tabs 232 adjacent the top of the case. Each of tabs 232 is provided with a generally centrally disposed aperture 236 extending through the tab.

A separate molded piece 240 has a generally semicircular recess 242 in the back which conforms to the upper front surface of outer case 230. Rear walls 244 extend laterally out from recess 242. Part of the rear surface of each of walls 244 substantially conforms to the front surface of a respective tab 232. Projecting rearward from each of walls 244 is a generally centrally disposed peg 246 with a barbed free end 248. The length of each peg 246, between the back of rear wall 244 and the back of barbed end 248, is substantially the same as the thickness of tab 232. At least the barbed ends of pegs 246 or tabs 232 are made of a material of sufficient resiliency to allow the barbed ends 248 to be pushed through apertures 236 and for pegs 246 to then be retained with walls 244 substantially abutting tabs 232.

The front of piece 240 is conveniently made to simulate a lower jaw or lip 250 of a person, animal or character. A head 252 is similar to head 180 except that it is provided with a simulated upper jaw or lip 254 of a person, animal or character and 186 may be configured to definitely be a nose or may be omitted. Moveable upper jaw or lip 254 and stationary lower jaw or lip 250 correspond and cooperate to enhance the appearance of the opening of a mouth upon pivoting of the head to dispense a confectionary.

While particular embodiments of the invention have been shown and described with some variations and alternatives, further variations and modifications will occur to those skilled in the art. It is intended in the appended claims to cover all such variations and modifications that come within the true spirit and scope of the present invention.

What is claimed as new and desired to be secured by Letters Patent is:

1. A confectioneries dispenser comprising:
a magazine carrying a number of the confectioneries;
a spring inside the magazine urging the confectioneries out of the magazine;
a head mounted for movement from a closed position to a dispensing position dispensing the outermost of the confectioneries from the magazine; and
a spring integrally formed as part of the magazine for returning the head from the dispensing position to the closed position.

2. The confectioneries dispenser of claim 1 in which the head is mounted on the magazine for pivotal movement.

3. The confectioneries dispenser of claim 1 in which the integrally formed spring comprises:
a first portion of the magazine extending beyond the outermost of the confectioneries and having an inner end and an outer end;
a second portion extending from the outer end of the first portion generally transverse to the first portion to an outer end of the second portion; and
a third portion transverse to the first portion and extending adjacent the inner end of the first portion in a direction transverse to the direction the second portion extends.

4. The confectioneries dispenser of claim 3 in which:
the magazine has a pair of spaced apart walls extending beyond the outermost of the confectioneries; and
the third portion extends between and is connected to the sidewalls.

5. The confectioneries dispenser of claim 3 in which:
the magazine has a pair of integral spaced apart walls extending beyond the outermost of the confectioneries;
an integral section extends between the spaced apart wall; and
the first portion is formed from the section by a pair of spaced apart slits in the section.

6. The confectioneries dispenser of claim 1 in which the head includes an elongated ejector that, when the head is moved to the dispensing position, pushes out only the outermost of confectioneries from the magazine and blocks the remaining confectioneries from being urged out by the bias of the spring inside the magazine urging the confectioneries out of the magazine.

7. The confectioneries dispenser of claim 1 including:
an outer case;
the outer case having an open end;
the magazine carrying the confectioneries at least partially inside the outer case; and
a portion of the magazine adjacent the open end causing an interference fit with the outer case.

8. The confectioneries dispenser of claim 1 in which:
the confectioneries are spherical; and
the magazine has a partially cylindrical enclosure of greater than one hundred and eighty degrees for retaining the spherical confectioneries.

9. The confectioneries dispenser of claim 8 in which the partially cylindrical enclosure of greater than one hundred and eighty degrees comprises:
a semi-cylindrical portion;
a pair of tangential edge extensions; and
a wedge shaped track inside of each extension to increase the cylindrical enclosure of the semi-cylindrical portion.

10. The confectioneries dispenser of claim 9 in which the semi-cylindrical portion, the tangential edge extensions, and the wedge shaped tracks are all integrally molded as part of the magazine.

11. The confectioneries dispenser of claim 1 including:
an outer case;
the magazine carrying a number of the confectioneries being at least partially inside the outer case;
the head mounted above the outer case having a lower front projection adjacent the outer case in the closed position of the head; and
the outer case having an upper front projection corresponding to the lower front projection of the head.

12. The confectioneries dispenser of claim 11 in which the lower front projection of the head and the upper front projection of the outer case simulate the upper and lower jaws or lips of a character's mouth.

13. The confectioneries dispenser of claim 12 in which the lower front projection of the head is integrally formed as part of the head and the upper front projection of the outer case is a separate piece secured to tabs integrally formed as part of the outer case.

14. A spherical confectioneries dispenser comprising:
a magazine carrying a number of the spherical confectioneries; and
the magazine having a partially cylindrical enclosure of greater than one hundred and eighty degrees for retaining the spherical confectioneries.

15. The confectioneries dispenser of claim 14 in which the partially cylindrical enclosure of greater than one hundred and eighty degrees comprises:
a semi-cylindrical portion;
a pair of tangential edge extensions; and
a wedge shaped track inside of each extension to increase the cylindrical enclosure of the semi-cylindrical portion.

16. The confectioneries dispenser of claim 15 in which the semi-cylindrical portion, the tangential edge extensions, and the wedge shaped tracks are all integrally molded as part of the magazine.

17. A confectioneries dispenser comprising:
an outer case;
a magazine at least partially inside the outer case carrying a number of the confectioneries;
a head mounted above the outer case for movement from a closed position to a dispensing position dispensing the outermost of the confectioneries from the magazine;
the head having a lower front projection adjacent the outer case in the closed position of the head; and
the outer case having an upper front projection corresponding to the lower front projection of the head.

18. The confectioneries dispenser of claim 17 in which the lower front projection of the head and the upper front projection of the outer case simulate the upper and lower jaws or lips of a character's mouth.

19. The confectioneries dispenser of claim 18 in which the lower front projection of the head is integrally formed as part of the head and the upper front projection of the outer case is a separate piece secured to tabs integrally formed as part of the outer case.
